(19) United States
(12) Patent Application Publication
(10) Pub. No.: US 2019/0026398 A1
(43) Pub. Date: Jan. 24, 2019

(54) METHOD AND SYSTEM FOR THE COMPUTER-AIDED MODIFICATION OF A MODEL OF A TECHNICAL SYSTEM GENERATED BY A MODELING TOOL

(71) Applicant: SIEMENS AKTIENGESELLSCHAFT, MÜNCHEN (DE)

(72) Inventors: STEPHAN STORCK, BAD FEILNBACH - AU (DE); NIKOLAUS REGNAT, MÜNCHEN (DE)

(21) Appl. No.: 16/039,727

(22) Filed: Jul. 19, 2018

(30) Foreign Application Priority Data
Jul. 21, 2017 (DE) 10 2017 212 578.0

(51) Int. Cl. G06F 17/50

(52) U.S. Cl. CPC G06F 17/50; G06F 3/04883

(57) ABSTRACT

Provided is a method for computer-aided modification of a model of a technical system generated by a modeling tool, the technical system being described in a formal modeling language by elements and their relationships, while taking properties into account, and graphically visualized on an output unit. The method includes sensing a manual user input on the input unit, the user input including a change of the graphic visualization of the model, analyzing the user input to determine a context of the user input in relation to an element and/or a relationship and/or a property of the modeled technical system, and assigning and storing the context of the user input in relation to the assigned element and/or relationship and/or property in the model of the technical system.

### CROSS-REFERENCE TO RELATED APPLICATIONS

This application claims priority to German application No. 10 2017 212 578.0 having a filing date of Jul. 21, 2017 the entire contents of which are hereby incorporated by reference.

### FIELD OF TECHNOLOGY

The following relates to a method and a system for the computer-aided modification of a model of a technical system generated by a modeling tool. The technical system is described in a formal modeling language by elements and their relationships, while taking properties into account. The model of the technical system is visualized on an output unit.

### BACKGROUND

In the present description, a technical system is understood as meaning a hardware system, a software system, a mechanical system, an electrical system or an electromechanical system. Generally, a technical system can be understood as meaning any system comprising hardware and/or software components.

Such a technical system can be described by an architecture specification, in which the technical system is described by elements and their relationships, while taking properties into account. Elements may be understood as meaning units (for example electrical and/or mechanical units), components (for example an electrical drive) or subsystems (for example a drive system with a number of drive motors).

The relationships take into account the interaction of the elements in a mechanical and/or electrical and/or functional respect. This takes place with the aid of properties, such as for example attributes, restrictions, quality features or draft guidelines. On the basis of the architecture specification, it is possible to generate interpretable graphic representations of the technical system, on the basis of which the technical system can be created and/or maintained.

The devising of an architecture concept for the technical system is performed initially on a computer. In a further step, the architecture concept is transferred into the formal model. By using domain-specific modeling languages (Domain Specific Language—DSL), it is attempted to bring a formal modeling language closer to the architect's respective model of the architecture concept, in order to reduce an element of transformation work required in the transfer into the formal model.

Domain-specific, graphic modeling languages and models, such as for example UML, SysML and the domain-specific languages mentioned, are often used as means of communication in the course of a discussion between a number of persons. Then there is the problem that changes to these graphic models can often only be carried out with difficulties, and only by one person with the aid of the modeling tool. It is consequently only with difficulty that desired changes can be made in a collaborative environment and transferred into the model with the aid of the modeling tool.

### SUMMARY

An aspect relates to a method and a system for the computer-aided modification of a model of a technical system generated by a modeling tool that allow computer-aided enhancement and modification of graphic models.

For this purpose, a method for the computer-aided modification of a model of a technical system generated by a modeling tool is proposed. The technical system is described in a formal modeling language by (graphic) elements and their relationships, while taking properties into account, and graphically visualized on an output unit. The output unit may for example be an interactive whiteboard, which allows not only the visualization of information, but also the acquisition of information.

The method comprises the steps of sensing a manual user input on the output unit, the user input comprising a change of the graphic visualization of the model. A change of the visualization should be understood in this case as meaning any change of the graphic model which, with the aid of the manual user input, brings about an alteration of the graphic model of the technical system reproduced on the output unit. The user input may be performed directly on the output means. The change may be performed for example by means of a pen, by handwritten inputs on the input unit. The change may also be performed with the aid of a technical input means, for example a mouse or a trackpad or a graphics tablet. In a next step, the analyzing of the user input is performed to determine a context of the user input in relation to an element and/or a relationship and/or a property of the modeled technical system. The analysis of the user input is performed with regard to formal and/or content-related aspects of the manual user input. Finally, assigning and storing the context of the user input are performed in relation to the assigned element and/or relationship and/or property in the model of the technical system.

This method allows established modeling tools, such as for example MagicDraw, to be extended by adding handwritten additions, which can be inserted as manual user inputs. In this case, the graphic model of the modeling tool is relied on with the aid of the method. The method allows the manual user inputs to be linked with the model elements.

The method consequently allows improved collaboration in the development of technical systems with the aid of modeling languages and modeling tools. The method in this case allows on the one hand modifications that arise in the course of discussions to be transferred more easily to the current model. On the other hand, an element of transformation work involved in transferring the changes into the model is also made easier.

An expedient refinement provides that, in the step of analyzing the user input, it is checked whether the user input, as an input of a first type, comprises the generation of a new element or a new relationship or, as an input of a second type, comprises the erasure of an existing element or a relationship. The check may be performed on the basis of prescribed graphic user inputs. Thus, for example, the intended erasure of an existing element or a relationship can be detected by the sensing of two obliquely crossing lines. The input of a first type for generating an element or a relationship may comprise checking for the input of prescribed shapes or lines.

A further expedient refinement provides that, when analyzing the user input, a type of user input is sensed, the type of user input comprising the determination of whether it represents an element or a relationship. This can be performed in an easy way by analysis of the graphic symbols or pictograms generated in the course of the manual user input and sensed in the method.

The type of user input may comprise the determination of which properties the element comprises. Properties may be for example a size and/or a shape and/or a type of line and/or graphic elements (for example pictograms). The properties of an element generated by means of user input may in this case be prescribed. In order for example to generate an electrical element, the user input is checked for whether a shape assigned to the electrical element (for example a rectangle) has been generated with a specific type of line (for example a solid line). By providing graphic elements, such as for example a pictogram (for example an exclamation mark within a circle) or the input of an electrical parameter (for example 10 kW) for the identification of a specific power class, they can be checked and evaluated for detecting the type of user input.

A further refinement provides that, when analyzing the user input, the location of the user input on the output unit is sensed and a position comparison with at least one element and/or relationship of the modeled technical system is carried out. By sensing the location of the user input and making a comparison of the position with existing elements or relationships of the graphically represented model of the technical system, it can be established whether there is a link between a manual user input and one of the elements or relationships.

Thus, according to an expedient refinement, an assignment to a specific element or relationship can be performed from a result of the position comparison. For example, it would be established in such a position comparison that the symbol used for an element to be erased (for example the two obliquely crossing lines) coincides with the location of the element to be erased in the visualized model. As a result, the wish to erase a specific element is deduced. It is not important here for there to be an identical match of the position, but a match within specific, prescribed limits, to allow for the fact that manual user inputs on the output means may be subject to certain positional fluctuations.

If on the other hand the user input is the input of a first type, that is to say the generation of a new element or a new relationship, there should not be an already existing element of the visualized model of the technical system at the location where the new element is generated. This allows a user input of the second type to be deduced from a result of the position comparison.

A further refinement provides that, in the step of assigning and storing the context of the user input, for a user input of the first type, a placeholder for the new element or the new relationship is created in the model. In this way, the transfer of the changes into the model of the technical system with the aid of the modeling tool is made easier.

According to a further expedient refinement, in the step of assigning and storing the context of the user input, for a user input of the second type, an element to be erased or a relationship to be erased is assigned an annotation about the erasure in the model. This also allows the initially only manually indicated wish for erasure to be more easily taken into account later in the transfer into the formal modeling language.

The method for the computer-aided modification of the modeling tool may be realized for example with the aid of a plug-in, which is capable of exchanging data with the modeling tool. This means that the extension is capable of transferring data to the modeling tool and for example storing it in a memory. Similarly, the extension is capable of reading data from the modeling tool. The main task of this extension is to allow the method to be realized, in order that the graphic elements and relationships created with the modeling tool with the aid of the user inputs can be edited and enhanced in a handwritten form.

Also proposed is a computer program product (non-transitory computer readable storage medium having instructions, which when executed by a processor, perform actions), which can be loaded directly into the internal memory of a digital computer and comprises software code portions with which the steps of the method described herein are executed when the product runs on the computer. The computer program product may take the form of a DVD, a CD-ROM, a USB stick or some other nonvolatile memory. The computer program product may also be wireless or wire-bound via a network as a loadable data signal.

The embodiments of the invention also proposes a system for the computer-aided modification of a model of a technical system generated by a modeling tool which is described in a formal modeling language by elements and their relationships, while taking properties into account, and graphically visualized on an output unit. The system comprises first means for sensing a manual user input on the output unit, the user input comprising a change of the graphic visualization of the model. The system comprises second means for analyzing the user input for determining a context of the user input in relation to an element and/or a relationship and/or a property of the modeled technical system. Finally, the system comprises third means for assigning and storing the context of the user input in relation to the assigned element and/or relationship and/or property in the model of the technical system.

The proposed system has the same advantages as explained above in connection with the method according to embodiments of the invention.

In addition, the system may comprise further means for carrying out the method according to embodiments of the invention, as set out in the present description.

### BRIEF DESCRIPTION

Some of the embodiments will be described in detail, with references to the following Figures, wherein like designations denote like members, wherein:

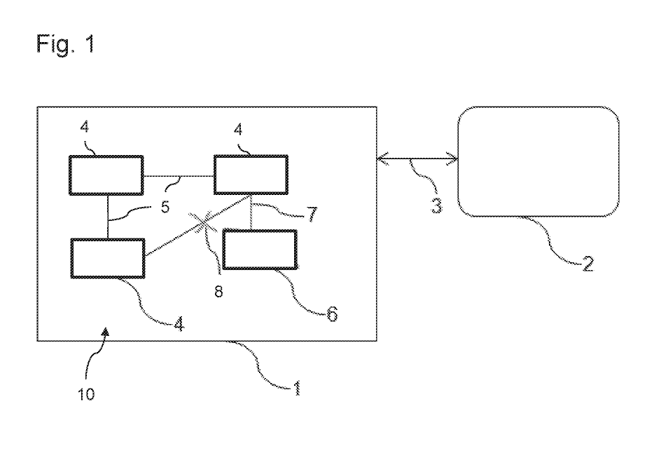

FIG. 1 shows a schematic representation of a model of a technical system generated and visualized with the aid of a modeling tool, together with an extension according to embodiments of the invention for the manual editing and enhancement of the model.

### DETAILED DESCRIPTION

FIG. 1 shows a graphic modeling tool 1, which is provided with an extension 2 (known as a plug-in). The modeling tool 1 may be a domain-specific modeling tool. General modeling tools, such as for example the MagicDraw software, are also possible. With the aid of the modeling tool 1, it is possible to visualize a model of a technical system on an output unit that is not represented any more specifically in FIG. 1. The technical system is in this case described in a formal, in particular graphic, modeling language, used by the modeling tool 1, by elements and their relationships, while taking properties into account.

Such a visualization of a model of a technical system is schematically indicated in FIG. 1 by the reference numeral 10. The model represented comprises by way of example three elements 4, which are in each case illustrated by rectangles. Once again merely by way of example, the elements 4 are connected to one another by relationships 5. The relationships 5 are represented by lines respectively connecting two elements 4.

A respective element 4 represents for example an electrical or mechanical or pneumatic unit, a component (for example an electrical drive) or a subsystem (for example a drive system with a number of drive motors) of the model. The relationships 5 between two elements 4 take into account the interaction of the elements in a mechanical or electrical or pneumatic or other respect.

In addition, further properties, such as for example attributes, restrictions, quality features or draft guidelines, can be visualized by the modeling tool 1. For the sake of simplicity, these are not represented in FIG. 1.

The visualization 10 of the model of the technical system takes place on an output unit, which in this exemplary embodiment is designed to sense and process user inputs. The output unit may be for example what is known as interactive whiteboard. This makes it possible to provide the visualization 10 with changes produced in a handwritten form, as schematically represented in FIG. 1. Such handwritten changes are in this case sensed by the already mentioned extension 2, processed and the result of the processing returned to the modeling tool 1. For this purpose, the modeling tool 1 and the extension 2 are connected by way of a communication channel 3, in order to allow the extension 2 to read or write data from the modeling tool 1.

With the reference numerals 6, 7 and 8, user inputs performed manually in the visualization 10 of the model are indicated. The user inputs 6, 7 are user inputs of the first type, i.e. user inputs that represent the generation of a new element 6 and a relationship 7. The user input 8 is an input of a second type, which comprises the erasure of an existing element (here: a relationship 5).

With the aid of the extension 2, the user inputs 6, 7, 8 are sensed and evaluated. The evaluation or analysis of the user inputs first checks whether it is an input of a first type (addition of a new element or a relationship) or an input of a second type (i.e. erasure of an existing element or a relationship). In a next step, it is checked whether an assignment and a context of the user input 6, 7, 8 in relation to an element 4 or relationship 5 generated by the modeling tool 1 can be established. For this purpose, a position comparison of a respective user input 6, 7, 8 with an element 4 and relationship 5 generated by the modeling tool 1 is carried out. If the position comparison shows that the user input was performed at a location of the input unit at which no element 4 and no relationship 5 are visualized, it is an input of a first type. This applies to the user inputs 6 and 7. If, on the other hand, the position comparison shows that an element 4 or a relationship 5 exists at the location of the user input, as applies to the user input 8, it is in particular an input of the second type.

In this exemplary embodiment, it is indicated by the user inputs 6, 7, 8 in the course of a collaboration between a number of users that the relationship 5 between the bottom left element 4 and the top right element 4 is to be erased, while at the same time a new element 6 is to be generated, and is to be connected to the top right element 4 by way of a new relationship 7. This context is created by an assignment of the elements that are new or to be erased to the elements that are defined in the formal modeling language of the modeling tool 1 and existing and their relationships. In particular, this involves the addition of an annotation to the relationship 5 to be erased and the creation of a new element 6 and a new relationship 7 and their connection to the top right element 4. The assigning and storing of this context is in this case performed in such a way that a further implementation of the then changed model can be performed by an expert in an easy way with the aid of the formal modeling language of the modeling tool 1.

An extension as described above can be integrated for example as a plug-in in a modeling tool 1, such as for example MagicDraw. The extension 2 thereby enables the user to make handwritten additions to the previously defined model, these changes or additions in a handwritten form being linked to the model elements that are already defined. It is in this case expedient if, in the visualization, user inputs in a handwritten form can be shown and hidden and also still edited or erased.

It is ensured by the linkage, for example of the new relationship 7 of the new element 6 to the top right element 4, that, when there is a displacement of the element 4 in the visualization, and the corresponding annotation of a linkage, the linkage is preserved. The same applies to the erased relationship 5, which in a changed optical visualization is also still represented as a line/relationship to be erased.

This procedure makes it possible to increase the acceptance of model-based approaches when modeling tools are used in a collaborative environment, such as for example a discussion. In particular, it provides the possibility of using electronic whiteboards or tablets for the input of handwritten information.

By linking handwritten inputs to existing model elements and relationships, a seamless further development of the technical model to be developed can be ensured. Methods for automatically refactoring the handwritten additions can be integrated. This contributes to improving the efficiency, and thereby reducing costs.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A method for computer-aided modification of a model of a technical system generated by a modeling tool, the technical system being described in a formal modeling language by elements and their relationships, while taking properties into account, and graphically visualized on an output unit, the method comprising the steps of:
a) sensing a manual user input on an input unit, the manual user input comprising a change of a graphic visualization of the model;
b) analyzing the manual user input to determine a context of the manual user input in relation to an element and/or a relationship and/or a property of the modeled technical system; and
c) assigning and storing the context of the manual user input in relation to the assigned element and/or relationship and/or property in the model of the technical system.

2. The method as claimed in claim 1, in which, in step b), it is checked whether the user input, as an input of a first type, comprises the generation of a new element or a new relationship or, as an input of a second type, comprises an erasure of an existing element or a relationship.

3. The method as claimed in claim 1, in which, in step b), a type of user input is sensed, the type of user input comprising the determination of whether the user input represents an element or a relationship.

4. The method as claimed in claim 3, in which the type of user input comprises the determination of which properties the element comprises, including a size and/or a shape and/or a type of line and/or graphic symbols.

5. The method as claimed in claim 1, in which, in step b), a location of the manual user input on the output unit is sensed and a position comparison with at least one element and/or relationship of the modeled technical system is carried out.

6. The method as claimed in claim 5, in which an assignment to a specific element or relationship is performed from a result of the position comparison.

7. The method as claimed in claim 5, in which a user input of the second type is deduced from a result of the position comparison.

8. The method as claimed in claim 2, in which, in step c), for a user input of the first type, a placeholder for the new element or the new relationship is created in the model.

9. The method as claimed in claim 2, in which in step c), for a user input of the second type, an element to be erased or a relationship to be erased is assigned an annotation about the erasure in the model.

10. A computer program product, comprising a computer readable hardware storage device having computer readable program code stored therein, said program code executable by a processor of a computer system to implement a method according to claim 1.

11. A system for computer-aided modification of a model of a technical system generated by a modeling tool, the technical system being described in a formal modeling language by elements and their relationships, while taking properties into account, and graphically visualized on an output unit, the system comprising:
a) a first means for sensing a manual user input on the output unit, the manual user input comprising a change of a graphic visualization of the model;
b) a second means for analyzing the user input for determining a context of the manual user input in relation to an element and/or a relationship and/or a property of the modeled technical system; and
c) a third means for assigning and storing the context of the user input in relation to the assigned element and/or relationship and/or property in the model of the technical system.
